(19) United States
(12) Patent Application Publication
(10) Pub. No.: US 2021/0010735 A1
(43) Pub. Date: Jan. 14, 2021

(54) PORTABLE COOLER

(71) Applicant: POLISUR 2000, S.L., Lepe/Huelva (ES)

(72) Inventor: JOSE LUIS FERNANDEZ SANTANA, LEPE/HUELVA (ES)

(21) Appl. No.: 16/704,492

(22) Filed: Dec. 5, 2019

(30) Foreign Application Priority Data
Jul. 12, 2019 (ES) U201931203

(51) Int. Cl. F25D 3/08; A45C 11/20

(52) U.S. Cl. CPC F25D 3/08; A45C 11/20

(57) ABSTRACT

The invention relates to a portable cooler having a multilayer structure, provided with a lid which enables it to be used in an upside-down position. Both the outer body and the lid have an outer layer as a polypropylene casing, an EPS-based intermediate layer and a polypropylene-based inner layer, having holes on the smaller inner faces thereof coinciding with each other for the passage of a rivet and an O-ring for fastening the carrying handle.

### TECHNICAL FIELD

The present invention relates to a portable cooler, which has a multilayer structure providing improved features for conserving the products housed therein.

The cooler also has a lid which, in addition to the conventional function thereof as a closing element, can be used as a tray in the upside-down position thereof, likewise enabling the cooler to be closed and insulated when it is placed on the opening thereof in such a position.

### BACKGROUND OF THE INVENTION

Although the use of portable coolers is notable, it is worth mentioning that normally these types of coolers are made up of a body with two layers, between which an insulation chamber is established, which also occurs with the corresponding lid, which only has the function of a hermetic closing of said cooler.

Essentially, these types of coolers have a limited thermal insulation capacity, which would be desirable to increase.

### DESCRIPTION OF THE INVENTION

The portable cooler that is recommended offers a completely satisfactory solution to the problem set out above, based on a novel and effective structure.

To do so, the first novel feature of the cooler of the invention is that both the lid and the body of the cooler are made up of three layers, an outer layer, an inner layer and an intermediate layer for each of the two elements.

The intermediate layer is made of EPS, while the external and internal layers or casings are made of polypropylene, the three layers being able to end in the same perimeter edge, or the inner casing having a small flange so that it exceeds and protrudes towards the outer portion, in order for water, sand or dirt to not be able to be introduced between the layers.

The three layers that participate in the main body of the cooler have a pair of holes in the sides thereof for anchoring the ends of the corresponding handle, anchoring which will be performed by an O-ring with a female rivet and the complementary male rivet, both made of polyamide, the holes obviously facing each other in the three layers making up the body of the cooler.

Another novel feature of the cooler of the invention is that the lid adopts a slightly convex curved configuration on the external face thereof, or at least on the perimeter while on the internal face thereof a stepped and flat recess is defined which, when turned upside-down, becomes a tray, the stepping of which defines an additional means of stabilisation and security for the objects arranged thereon, while the rounded outer border of the lid enables it to adapt in a perfect and sealed manner to the internal border of the opening of the cooler, thereby preventing the cold chain from being broken.

All the edges of the cooler will be significantly rounded, in order to achieve optimal ergonomics for the cooler.

Finally, it is worth mentioning that the shape of an essentially inverted truncated pyramid with a rectangular base and significantly rounded edges, together with the configuration of the lid, make the flexible carrying handle or band press the lid against the opening of the main body due to the very weight of the body when hung from the shoulder or a hand of the user, thereby ensuring a perfect closure, without needing to implement expensive closing mechanisms.

In this manner, a cooler with high insulation features is achieved, enabling the products contained therein to be kept for up to 12 hours between 5 and 15° C.

### BRIEF DESCRIPTION OF THE DRAWINGS

As a complement to the description that will be provided herein, and for the purpose of helping to make the features of the invention more readily understandable, according to a preferred practical exemplary embodiment thereof, said description is accompanied by a set of drawings constituting an integral part thereof in which, by way of illustration and not limitation, the following is represented:

FIG. 1 shows a perspective view of a portable cooler made according to the object of the present invention.

FIG. 2 shows a perspective view of the cooler of the previous figure without the lid thereof.

FIG. 3 shows, finally, a perspective and exploded view of the different elements participating in the cooler of the invention.

### PREFERRED EMBODIMENT OF THE INVENTION

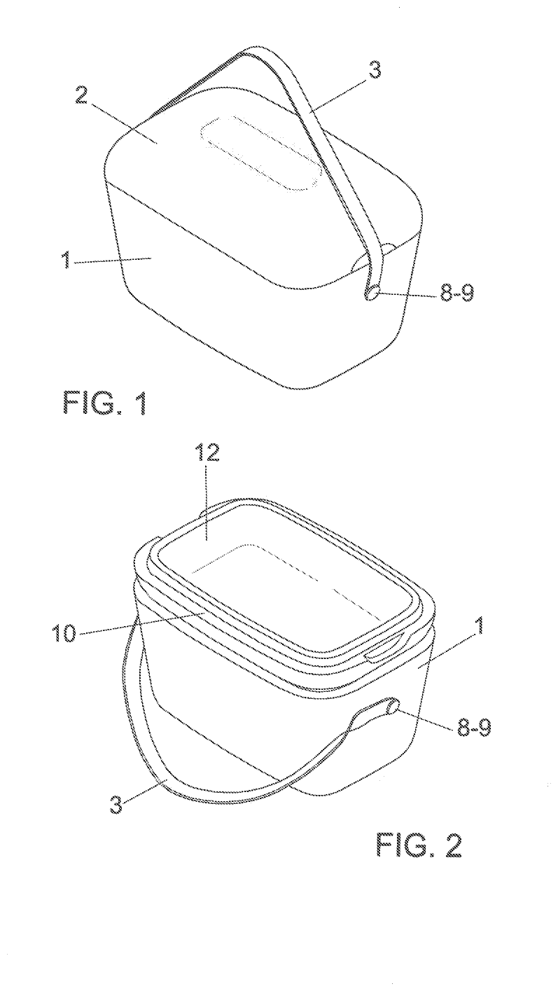

In light of the figures discussed above, and in particular FIG. 1, it can be seen how the portable cooler of the invention is made up of a main body (1) open at the top and a coupling lid (2) on the former, the cooler assembly being complemented with a handle (3) for manually carrying the cooler.

The main body (1) is made up of three layers, an outer layer (4) as a polypropylene-based casing, an EPS-based intermediate layer (5), and a likewise polypropylene-based inner layer (6) or casing, the three elements being coupled to each other in order to make up said main body (1), with the special particularity that these elements have holes (7) on the smaller faces thereof coinciding with each other for the passage of a rivet (9) and an O-ring (8) for fastening the carrying handle (3).

Moreover, the lid (2) is likewise made up of three layers, an external layer (11) as a polypropylene-based casing, an EPS-based intermediate core (10), and a likewise polypropylene-based internal layer (12) or casing, said three layers being coupled to each other just like the main body of the cooler.

The O-ring (8) and the rivet (9) are made of polyamide, while the handle (3) is made of cowhide or similar.

As mentioned previously, and according to FIG. 2, the lid (2) adopts a slightly convex curved configuration on the external face thereof, or at least on the perimeter while on the internal face thereof a stepped and flat recess is defined which, when turned upside-down, is made to become a tray, such that the rounded outer border of the lid enables it to adapt in a perfect and sealed manner to the internal border of the main body (1) of the cooler.

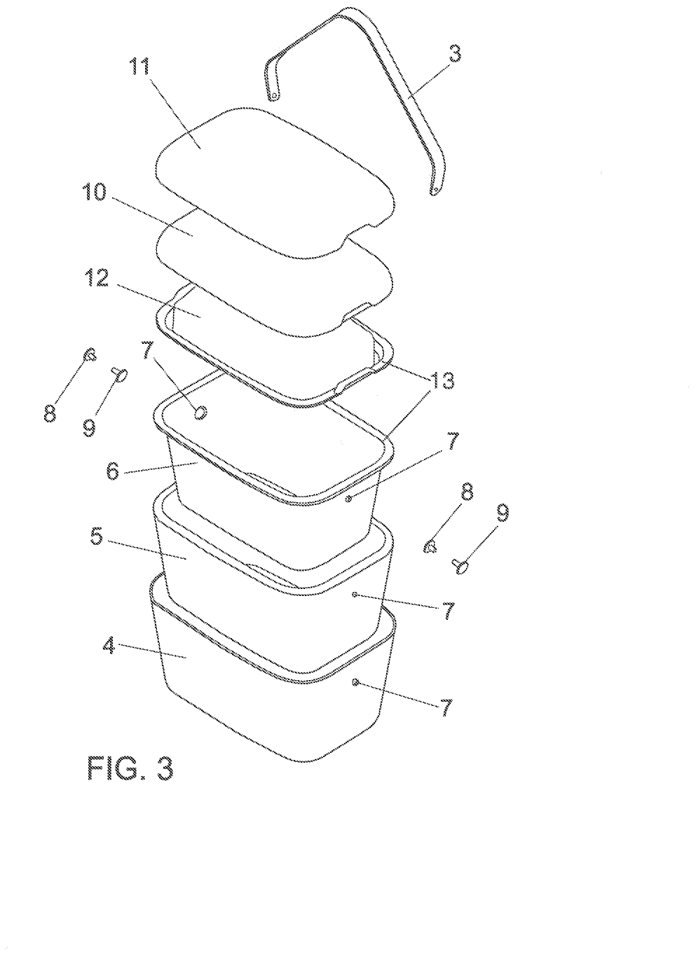

As for the inner layers or casings of both the lid and the main body, they may go to the same edge as the outer and intermediate casing or, as shown in FIG. 3, the inner layer may have an external perimeter flange (13) covering the other two layers, with the aim of water or dirt not being able to be introduced between said layers.

As mentioned previously, the shape similar to an inverted truncated pyramid with a rectangular base and significantly rounded edges, meaning diverging in the upward direction, together with the configuration of the lid, make the carrying handle or band press the lid against the opening of the main body when carried, thereby ensuring a perfect seal with a structure that is incredibly simple and therefore cost-effective.

1. A portable cooler, being of the type made up of a main body (1) open at the top, with significantly rounded edges, and a coupling lid (2) on the former, the cooler assembly being complemented with a handle (3) for manually carrying the cooler attached to said main body, characterised in that both the main body (1) and the lid (2) are made up of three layers, an outer layer (4-11) as a polypropylene-based casing, an EPS-based intermediate layer (5-10), and a polypropylene-based inner layer (6-12), the three layers of the main body having holes (7) on the smaller faces thereof coinciding with each other, for the passage of a rivet (9) and an O-ring (8) for fastening the carrying handle (3).

2. The portable cooler, according to claim 1, characterised in that the lid (2) adopts a slightly convex curved configuration on the external face thereof, or at least on the perimeter while on the internal face thereof a stepped and flat recess is defined which, when turned upside-down and providing watertight support on the opening of the cooler, defines a tray.

3. The portable cooler, according to claim 1, characterised in that the O-ring (8) and the rivet (9) are made of polyamide, while the handle (3) is made of cowhide or similar.

4. The portable cooler, according to claim 3, characterised in that the main body has a divergent configuration in the upward direction, so that when the cooler is carried, the handle (3) presses on the lid (2) against the opening of the main body (1).

5. The portable cooler, according to claim 1, characterised in that the inner layers or casings of both the lid and the main body in the assembly thereof are flush with the outer and intermediate casing.

6. The portable cooler, according to claim 1, characterised in that the inner layers or casings of both the lid and the main body in the assembly thereof include an external perimeter flange (13) covering the other two layers.
